(19) United States
(12) Patent Application Publication
(10) Pub. No.: US 2013/0092686 A1
(43) Pub. Date: Apr. 18, 2013

(54) COLLAPSIBLE CONTAINER

(71) Applicant: Sarine Sabounjian, Irvine, CA (US)

(72) Inventor: Sarine Sabounjian, Irvine, CA (US)

(73) Assignee: Pro-Mart Industries, Inc., Irvine, CA (US)

(21) Appl. No.: 13/360,555

(22) Filed: Jan. 27, 2012

Related U.S. Application Data
(60) Provisional application No. 61/548,672, filed on Oct. 18, 2011.

(51) Int. Cl. B65D 33/02; B23P 17/04

(52) U.S. Cl. 220/9.2; 29/428

(57) ABSTRACT

A collapsible container has at least three panels, including a center panel and first and second side panels. Each panel has a tension loop frame fastened to a web of flexible material. The center panel has two sides each fastened to a first side of a different side panel. Each side panel has a second side fastened by a zipper to form the panels into a triangular tube. Third and fourth side panels having a first side are optionally fastened to a different side of the center panel with a second side of the third and fourth panels fastened by a zipper to form the four side panels into a quadrilateral tube. Each side panels has a bottom side with a container bottom permanently fastened to a plurality of the bottom sides and fastened by one of the zippers to another of the bottom sides.

### CROSS-REFERENCE TO RELATED APPLICATIONS

This Application claims the benefit under 35 U.S.C. §119(e) of Provisional Patent Application No. 61/548,672 filed Oct. 18, 2011, the complete contents of which are incorporated herein by reference.

### BACKGROUND

Collapsible containers are known that have four rectangular sides, a bottom and open top. Twist-and-fold frames are contained in pockets around the periphery of each side panel so that opposing sides can be folded against each other, and then the flexible frames twisted into two or three overlapping loops or circles to form a collapsible hamper. The flexible frames contained in pockets are also used to make containers with curved sides. Such collapsible containers are shown and described in U.S. Pat. Nos. 5,971,188 to Kellogg and 5,964,533 to Ziglar. The frames are of relatively small cross-section compared to the length of the frame in order to allow the twisting-and-folding of the frame into small, portable packages. The flexible structures are also used for collapsible containers used to carry items.

These containers typically have four sides which are folded on top of each other for form a stack of side panels, with each side panel having a separate frame. The stacked panels are then twisted and moved into overlapping coils to form a more compact assembly for storage and shipping. Tension loop frames fastened to flexible webs of material are twisted and folded into overlapping coils for shipping and storage with the frames uncoiling to form panels that are joined along adjoining sides with the panels being unfolded to form containers. Because the adjoining side panels are fastened together, typically be sewing the pockets of adjacent side panels together, the side panels must be about the same size or else the panels don't coil properly.

### BRIEF SUMMARY

A collapsible container is provided having three panels, or five panels, depending on the configuration of the container. The three panel container includes three panels comprising a center panel and first and second side panels. Each panel preferably has a tension loop frame fastened to a web of flexible material. The center panel has two sides each fastened to a first side of a different side panel. Each side panel has a second side with each of the second sides having a first releasable fastening mechanism to releasably fasten them together to form the panels into a triangular tube.

In further variations, each panel has a bottom side and further includes a container bottom permanently fastened to at least one of the bottom sides of the panels and releasably fastened to the bottom side of another of the panels. The releasable fastening mechanism advantageously comprises a zipper extending along at least a portion of the second sides. The zipper advantageously releasably also fastens the container bottom to the bottom of the different one of the bottom sides of the panels.

To form a four sided container the container has third and fourth side panels each having a tension loop frame fastened to a web of flexible material. The third and fourth panels each have a first side fastened to a different side of the center panel. The third and fourth panels have a second side with a second releasable fastening mechanism to releasably fasten them together to form the four side panels into a quadrilateral tube. The center panel extends between opposing corners of the quadrilateral and forms a diagonal divider.

Advantageously, the third and fourth panels each have a bottom side and the container bottom is permanently fastened to one of those bottom sides and releasably fastened to another of the bottom sides of the third and fourth panel. As in the three sided container, the four sided container, the second releasable fastening mechanism preferably comprises a zipper extending along at least portion of the second sides of the third and fourth panels. The zipper preferably also releasably fastens the container bottom to the bottom sides of one of the third or fourth panels. Advantageously, in both the three and four sided containers, the side panels are generally rectangular in shape.

The center panel has a width measured between its opposing sides that is greater than a width of any of the side panels. When the panels and container bottom are zipped together a container is formed with a closed end. When the panels and bottom are unzipped the frames may be stacked into a series of generally parallel panels. If the panels all have flexible frames the frames may be twisted and coiled into overlapping loops to further reduce the maximum size of the container. The coiled frames are restrained for shipment, as for example by elastic loops of material, or by placing the coiled loops into a pocket or pouch fastened to one of the panels as shown in FIGS. 6a-6d.

There is also provided a method of forming a collapsible container that includes: releasably fastening together a second side of first and second side panels to form a triangular shape, where each side panel has a first side fastened to an opposing side of the central panel. Each panel preferably comprises a tension loop frame fastened to a web of material. The panels each have a bottom side with a container bottom fastened to at least one of the bottom sides and releasably fastened at least another of the bottom sides to form a three sided container having an end formed by the container bottom. Advantageously, the releasable fastening is implemented by a zipper.

The method also includes forming a four sided container by releasably fastening together a second side of third and fourth side panels to form a triangular shape with the center panel, where each third and fourth side panel has a first side fastened to an opposing side of the central panel. Advantageously the third and fourth side panel are formed using a tension loop frame fastened to a web of material. The third and fourth side panels each have a bottom side with the container bottom being permanently fastened to one of the bottom sides of the third and fourth panels and releasably fastened to the other of the bottom sides of the third and fourth panels. Advantageously zippers implement the releasable fastening.

When the zippers connect the panels a four sided container is provided with the center panel forming a divider extending across opposing corners of the container. The center panel has a width measured between its opposing sides that is greater than a width of any of the side panels. When the zippers are unfastened the panels may folded to form a stack of panels. If all of the panels are twist and fold frames the panels may be twisted and coiled into overlapping coils to further reduce the maximum dimension of the container for shipping and storage. The center panel has a width measured between its opposing sides that is greater than a width of any of the side panels.

### BRIEF DESCRIPTION OF THE DRAWINGS

FIG. 1 is a perspective view of a four sided collapsible container in an expanded configuration;

FIG. 2 is a top perspective view of the container of FIG. 1;

FIG. 3 is a bottom view of the container of FIG. 1;

FIG. 4 is a top perspective view of the container of FIG. 1 in a partially collapsed configuration;

FIG. 5 shows the container of FIG. 1 in a generally planar, collapsed configuration with the panels generally parallel to each other;

FIGS. 6a-6d show a series of schematic views in which a stack of generally planar panels are twisted and coiled into overlapping coils;

FIG. 7 is a perspective view of a three sided container in an expanded configuration;

FIG. 8 is a top perspective view of the three sided container of FIG. 7 from the opposing side;

FIG. 9 is a perspective view of the container of FIG. 7 with the sides of the side panels unjoined and with the container bottom partially unjoined to the adjacent side panel;

FIG. 10 is a cross-sectional view taken along 10-10 of FIG. 1 showing three frames each contained in separate pockets that are sewn together;

FIG. 11 is a cross-sectional view of an alternative embodiment of the frames shown in FIG. 10, showing three frames in a single pocket.

### DETAILED DESCRIPTION

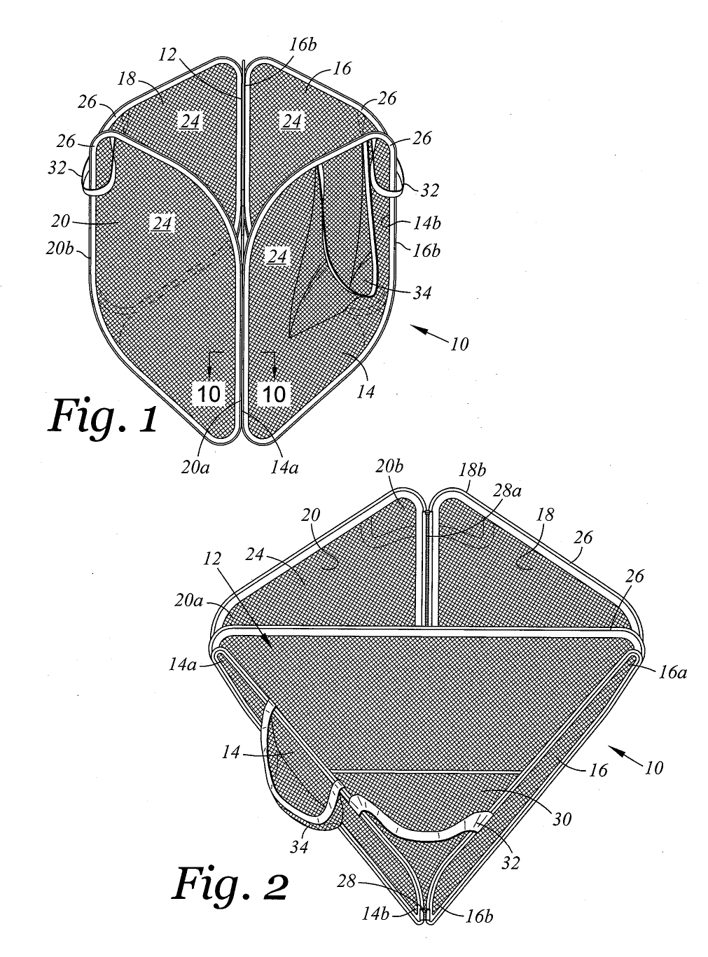

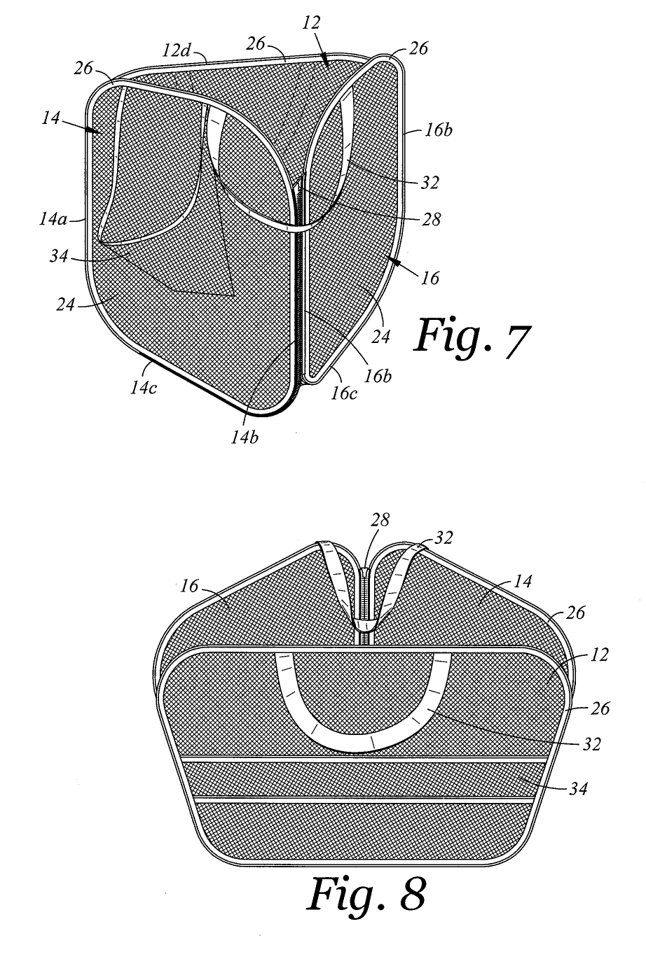

Referring to FIGS. 1-3, a four-sided container 10 is formed of five panels 12, 14, 16, 18 and 20. Panel 12 is the center panel, panels 14 and 16 are the first and second side panels, respectively, and panels 18 and 20 are the fourth and fifth side panels, respectively. Each panel is preferably formed by a tension loop frame 22 that is fastened to a web of flexible material 24 in various ways. The four sided container 10 of FIG. 1 has a divider 12, and can be viewed as a two three sided containers sharing that divider 12. The construction of such a three sided container containing panels 12, 14 and 16 is shown in FIGS. 7-9, so either set of figures may be referred to for guidance on the assembly of that portion of the four sided container, and the analogous construction of the other portion of the four sided container.

Preferably each frame 22 is contained in a separate pocket 26 fastened to a web of material 26, as by sewing, adhesives, riveting, melting, etc. Portions of the frames 22 may be placed in common pockets if those portions are sufficiently aligned during use of the container 10. The sides b or c of frames 22 of adjacent panels may be twisted together in loose coils as described in U.S. Pat. No. 6,494,353, the complete contents of which are incorporated herein by reference. The web of material 24 can be made from Nylon, canvas, plastic or other materials, which may have open weaves for ready air passage for use in clothes hampers, close weave for holding small items, or even water tight material.

Each panel has sides a and b, a top c and a bottom d. The center panel 12 thus has two opposing sides 12a, 12b, each fastened to a first side of a different side panel 14, 16. FIG. 1 shows center panel 12 fastened to the first side 14a, 16a of panels 14 and 16, respectively. Panel 12 is preferably permanently fastened to side panels 14, 16, as by sewing the pockets 26 of each panel together, or for example, placing the aligned sides 12a, 14a, 16a in a common pocket 26 (FIG. 6). The second side 14b, 16b of each side panel 14, 16 is releasably fastened together by releasable fastening mechanism 28. The fastening mechanism 28 is preferably a zipper having portions extending along at least a portion of the length of each second side 14b, 16b, and preferably extending along the entire length to join the entire length of the sides 14b, 16b.

A container bottom 30 is fastened to at least some of the bottoms 12c, 14c, 16c, 18c and 20c of the panels, is preferably fastened to all of the bottoms, and is less preferably fastened to the bottoms of the side panels 14c, 16c, 18c and 20c but not to the bottom of the center panel 12c. Advantageously, the container bottom 30 is permanently fastened to the bottom 12c of panel 12 and also to one of the bottoms 14c or 16c of the side panels 14, 16, with the other of the bottoms 14c or 16c being releasably fastened, as by the fastening mechanism 28. The permanent fastening may be achieved as described above regarding fastening sides 12a, 12b and the releasable fastening may be achieved as described regarding fastening sides 14b and 16b. In the preferred embodiment, the zipper 28 thus extends from adjacent bottom 12c of center panel 12, along one of the bottom sides 14c, 16c, and up the sides 14b, 16b.

The third and fourth side panels 18 and 20 are joined to the center panel 12 like the first and second side panels 14, 16, respectively. Thus, FIG. 10 shows center panel 12 fastened to the first side 18a, 20a of panels 18 and 20, respectively. Panel 12 is preferably permanently fastened to side panels 18, 20, as by sewing the pockets 26 of each panel together, or for example, placing the aligned sides 12a, 18a, 20a in a common pocket 26 (FIG. 11). The second side 18b, 12b of each side panel 18, 20 is releasably fastened together by a second releasable fastening mechanism 28a. The second fastening mechanism 28a is preferably a zipper having portions extending along at least a portion of the length of each second side 18b, 20b, and preferably extending along the entire length to join the entire length of the sides 18b, 20b.

Advantageously, the container bottom 30 is permanently fastened to the bottom 12c of panel 12 and also to one of the bottoms 18c or 20c of the side panels 18, 20, with the other of the bottoms 18 or 20 being releasably fastened, as by the second fastening mechanism 28a. The permanent fastening may be achieved as described above regarding fastening sides 12a, 12b and the releasable fastening may be achieved as described regarding fastening sides 14b and 16b. In the preferred embodiment, the zipper 28a thus extends from adjacent bottom 12c of center panel 12, along one of the bottom sides 18, 20, and up the sides 18, 20b. Advantageously, the first and second releasable fastening mechanisms 28, 28a extend along opposing bottom sides c, and thus preferably extend along bottom sides 14c, 18c or 16c, 20c.

When all of the panels are in the expanded configuration and joined together by releasable fastening mechanisms 26, 26a, the container 10 has an expanded configuration that will vary with the shape of the panels 12. In the depicted embodiment the expanded configuration of container 10 is a rectangular tube, with the bottom 30 closing the tube at one end. The center panel 12 forms a divider extending between diagonally opposed corners of the rectangular container 10. The center panel has a width measured between its opposing sides that is greater than a width of any of the side panels.

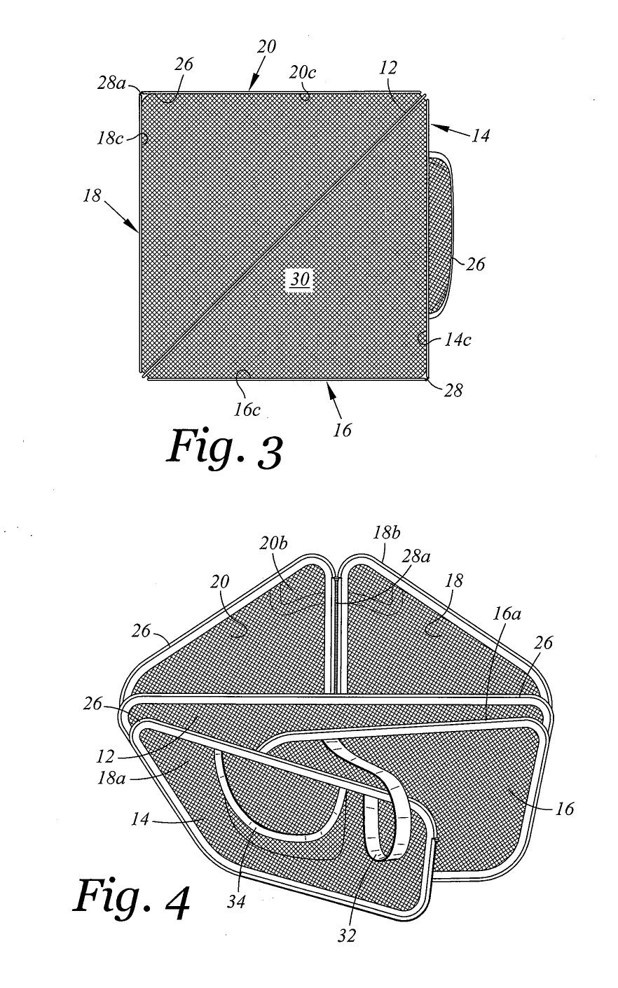

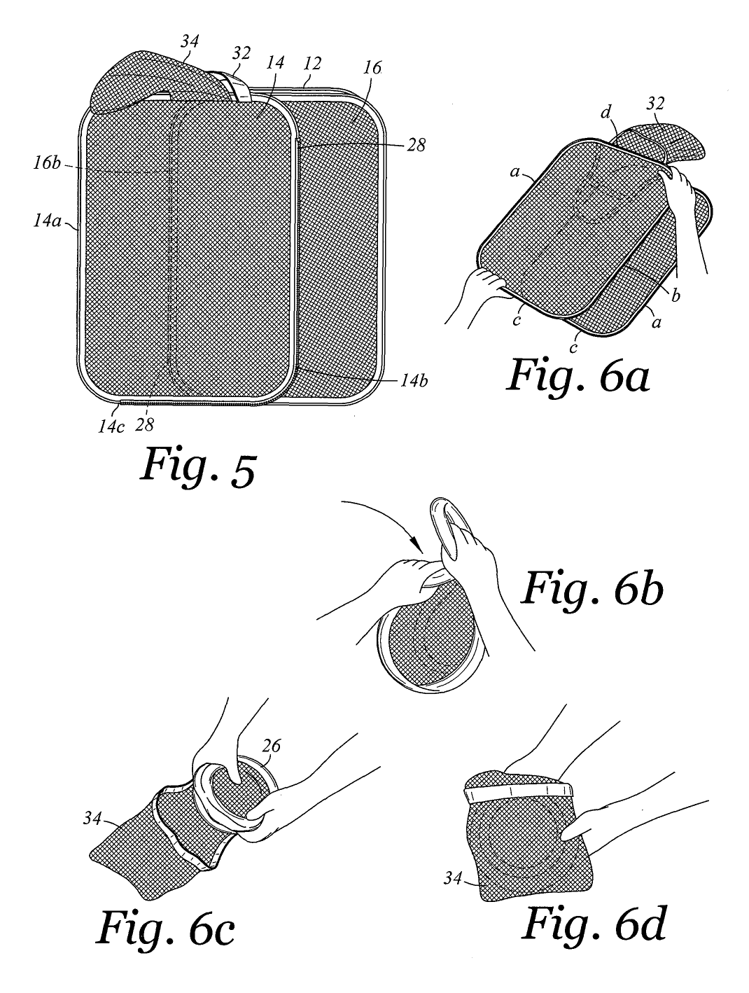

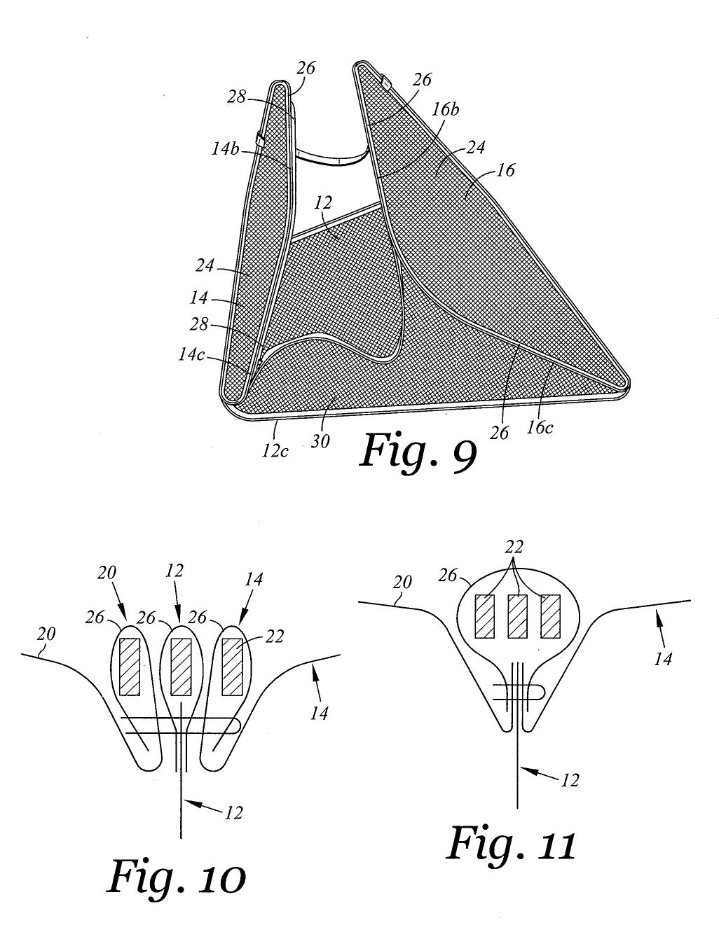

Referring further to FIGS. 4-6 and 9, the container 10 is collapsed from its expanded, use configuration by placing the side panels 14, 26, 18 and 20 generally parallel to the center panel 12 to form a stack of panels as shown in FIGS. 4-5 and. The releasable fastening mechanisms 26, 26a are first unfastened to uncouple the sides of the joined side panels otherwise the side panels will not lay flat against the center panel 12 or generally parallel to the center panel 12. This is also shown in FIG. 9. The container bottom 30 is preferably stuffed inside some of the stacked panels to hold it in place. The stacked side panels may be further collapsed by twisting and folding the stacked panels to form overlapping coiled frames 20. If the bottom fastener 26 is not unfastened to uncouple at least one of the bottom sides c on each side of the center panel 12, then the container bottom may restrain the coiling of the panel to which the bottom is attached and make it difficult or impossible to coil the panel frames into overlapping coils.

The releasable fastening mechanisms 26, 26a are shown as joining second sides b of the side panels 14, 16, 18 and 20, with the first sides of panels 16, 18 a being permanently fastened to center panel 12. It is also believed possible to place the releasable fastening mechanisms 28, 28a along one sides 12b of center panel 12 and along one of the bottoms 12c, 14c or 16c of the other panels.

The panels 12, 14, 16, 18 and 20 are shown having a generally rectangular shape, but other shapes could be used, including circular or oval shapes with curved sides, or various polygon shapes including trapezoidal or even triangular shapes in which case the top of each panel would represent the curved apex of the corner joining the opposing and inclined sides. Preferably, though, there are two opposing and generally parallel sides b and c, and opposing and generally parallel bottom c and top d. Because the frames 22 form rounded corners it is easy to use zippers 28, 28a to fasten various panels and to zip around the corners.

The shape of the container bottom 30 preferably conforms to the cross-sectional shape of the container 10. For the rectangular shaped container 10 shown in FIG. 1, the container bottom 30 has a generally square shape (FIG. 3. The container bottom 30 is preferably fastened to the bottoms c of the side panels forming the exterior periphery of the container 10 to form a container closed at one end by the bottom 30. The container bottom 30 may also be fastened to the bottom 12c of the center (divider) panel 12 to form two joined containers on opposing sides of the center panel 12.

The releasable fastener mechanisms 26, 26a are shown as zippers, but other releasable fasteners could be used, including snaps, buttons, toggles, releasable adhesives and hook and loop fasteners. The same type of releasable fastening mechanism need not be used on both mechanisms 26, 26a. Likewise, the same type of releasable fastening mechanism and need not be used on the sides a, b and bottom c of the panels 12, 14, 16, 18 or 20.

Referring to FIG. 1, the collapsible container 10 is shown as a quadrilateral container with a center divider panel 12 extending between opposing corners of the container. It may also be viewed as two triangular containers having a common side panel 12. The principles used to form the four sided container 10 may thus be used to form a three sided container 10. Such three sided containers fit conveniently into corners.

Referring to FIGS. 7-9, a three sided container is shown. The construction of the three sided container is just like the construction and joinder of center panel 12 and the first and second side panels 14, 16, and is referred to above. The construction will not be repeated. The container bottom 30 is triangular in shape.

Handles 32 may optionally be fastened to one or more panels 12, 14, 16, 18 or 20 of the container 10. Likewise, one or more pouches or pockets 32 may be optionally fastened to one or more of the panels 12, 14, 16, 18 or 20. Such pouches and handles are known in the art and not described in detail herein. The frame 22 is preferably metal and small enough in cross-section relative to the length of the frame to allow the frame to coil into overlapping coils. The center panel 12 could have a construction that does not have a tension loop frame. In such a construction the side panels 14, 16, 18 or 20 could be placed adjacent to and generally parallel with the center panel 12 to form a stack of generally flat panels, but the configuration could not be further reduced by coiling the stacked panels into overlapping coils.

The tension loop frames 22 are preferably continuous loops of material, preferably metal or plastic. The frames 22 are preferably small enough compared to the length to be coiled into at least one overlapping loop. If they cannot coil, the stacked configuration of panels is the shipping and storage configuration. Some of the frames 22 could be dis-continuous in that each panel tops d and panel bottoms c are formed by separate frames 22 but adjacent panels could share common sides b or c. In short, the tops d and bottoms c of two adjacent panels are fastened a single side b or c. Clamps, or other joining methods can be used to join the bottoms c and tops d to the common side b or c. This is described in m ore detail in U.S. Pat. No. 7,845,507, the complete contents of which are incorporated herein by reference.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The above description is given by way of example, and not limitation. Given the above disclosure, one skilled in the art could devise variations that are within the scope and spirit of the invention, including various ways of releasably fastening the side panels 14, 16, 18 and 20 to the center panel 12, and of releasably fastening the bottoms c to the container bottom 30. Further, the various features of this invention can be used alone, or in varying combinations with each other and are not intended to be limited to the specific combination described herein. Thus, the invention is not to be limited by the illustrated embodiments but is to be defined by the following claims when read in the broadest reasonable manner to preserve the validity of the claims.

What is claimed is:

1. A collapsible container, comprising:
three panels comprising a center panel and first and second side panels, each panel having a tension loop frame fastened to a web of flexible material, the center panel having two sides each fastened to a first side of a different side panel, each side panel having a second side, the second sides having a first releasable fastening mechanism to releasably fasten them together to form the panels into a triangular tube.

2. The collapsible container of claim 1, wherein each panel has a bottom side and further comprising a container bottom permanently fastened to at least one of the bottom sides of the panels and releasably fastened to another of the bottom side of another of the panels.

3. The collapsible container of claim 1, wherein the releasable fastening mechanism comprises a zipper extending along at least a portion of the second sides.

4. The collapsible container of claim 2, wherein the releasable fastening mechanism comprises a zipper extending along a portion of the second sides.

5. The collapsible container of claim 2, wherein a zipper releasably fastens the container bottom to the bottom of the different one of the bottom sides of the panels.

6. The collapsible container of claim 5, wherein the zipper further releasably fastens the container bottom to the different one of the bottom sides of the panels.

7. The collapsible container of claim 7, wherein the side panels are generally rectangular in shape.

8. The collapsible container of claim 1, further comprising third and fourth side panels each having a tension loop frame fastened to a web of flexible material, the third and fourth panels each having a first side fastened to a different side of the center panel, the third and fourth panels having a second side with a second releasable fastening mechanism to releasably fasten them together to form the four side panels into a quadrilateral tube.

9. The collapsible container of claim 8, wherein the third and fourth panels each have a bottom side and wherein the container bottom is permanently fastened to one of those bottom sides and releasably fastened to another of the bottom sides of the third and fourth panel.

10. The collapsible container of claim 8, wherein the second releasable fastening mechanism comprises a zipper extending along at least portion of the second sides of the third and fourth panels.

11. The collapsible container of claim 10, wherein the second releasable fastening mechanism comprises a zipper that extends along at least a porting of the second sides of the third and fourth panels and that also releasably fastens the container bottom to the bottom sides of one of the third or fourth panels.

12. The collapsible container of claim 10, wherein the side panels are generally rectangular in shape.

13. The collapsible container of claim 9, wherein the center panel has a width measured between its opposing sides that is greater than a width of any of the side panels.

14. The collapsible container of claim 2, wherein the center panel has a width measured between its opposing sides that is greater than a width of any of the side panels.

15. The collapsible container of claim 1, wherein the flexible frames are coiled into overlapping loops.

16. The collapsible container of claim 1, wherein the center panel is a generally flat, panel with a rectangular shape and the two side panels are also generally flat and laying generally parallel to the center panel.

17. The collapsible container of claim 8, wherein the center panel is a generally flat, panel with a rectangular shape and the first, second, third and fourth side panels are also generally flat and laying generally parallel to the center panel.

18. A method of forming a collapsible container, comprising:
releasably fastening together a second side of first and second side panels to form a triangular shape, where each side panel has a first side fastened to an opposing side of the central panel and each panel comprises a tension loop frame fastened to a web of material, the panels each having a bottom side with a container bottom fastened to at least one of the bottom sides, and releasably fastening the container bottom to at least another of the bottom sides.

19. The method of claim 18, wherein the releasably fastening steps are implemented by a zipper.

20. The method of claim 18, further comprising:
releasably fastening together a second side of third and fourth side panels to form a triangular shape with the center panel, where each third and fourth side panel has a first side fastened to an opposing side of the central panel and each third and fourth side panel comprises a tension loop frame fastened to a web of material; the third and fourth side panels each having a bottom side with the container bottom being permanently fastened to one of the bottom sides of the third and fourth panels and releasably fastened to the other of the bottom sides of the third and fourth panels. The collapsible container of claim 1, further comprising third and fourth side panels each having a tension loop frame fastened to a web of flexible material, the third and fourth panels each having a first side fastened to a different side of the center panel, the third and fourth panels having a second side with a second releasable fastening mechanism to releasably fasten them together to form the four side panels into a quadrilateral tube.

21. The method of claim 18, wherein the center panel has a width measured between its opposing sides that is greater than a width of any of the side panels.

22. The method of claim 20, wherein the center panel has a width measured between its opposing sides that is greater than a width of any of the side panels.
